(19) United States
(12) Patent Application Publication
(10) Pub. No.: US 2007/0018947 A1
(43) Pub. Date: Jan. 25, 2007

(54) Infrared transmitter/receiver accessory and system for portable photo player

(75) Inventor: Guillermo L. Toro-Lira, Sunnyvale, CA (US)

Correspondence Address: THELEN REID & PRIEST, LLP, P. O. BOX 640640, SAN JOSE, CA, 95164-0640, US

(73) Assignee: Panelvision Technology, a California Corporation

(21) Appl. No.: 11/185,928

(22) Filed: Jul. 19, 2005

(51) Int. Cl. G09G 5/00

(52) U.S. Cl. 345/156

(57) ABSTRACT

A system and a consumer electronics kit include an infrared transmitter module and an infrared receiver module. The infrared transmitter module includes a video input that a user can connect to a video output of a portable image display/storage device. The infrared receiver module includes an infrared detector configured to receive infrared signals from said infrared transmitter module, where the received infrared signals contain image information of one or more images stored on the portable image display/storage device. The image information may be still image data representing photographs, moving image data, image data generated by an application program. The infrared receiver module includes a connector that a user can connect to a video input of an electronic device. The electronic device may comprise a display device such as a television or computer monitor, an LCD display, or a portable viewer housing the infrared receiver module and an LCD display.

### FIELD OF THE INVENTION

The present invention is directed at an infrared transmitter/receiver display system that is operable to display images, on an external display device, of image data stored on a portable image display/storage device.

### BACKGROUND OF THE INVENTION

Just late last year, Apple Computer, Inc. released a photo version of its popular iPod MP3 player, which also allows a user to store, organize and display digital photographs. The device has been referred to as the “iPod Photo”. As shown in FIG. 1, an iPod Photo 10 includes, in addition its preexisting MP3 player, a very small (2″) display 100 and a user interface 102 that allows a user to control the display and organize digital photos stored on the device. Based on the initial sales and popularity of the iPod Photo, other MP3 players having digital photo storage and display capabilities will likely follow from other vendors and manufacturers.

While portable MP3/photo display/storage devices are useful in storing and organizing digital photographs, a major limitation of their use is that the display screen of the device is so small that the photographs are difficult to view, and the details of the photographs cannot be clearly seen. To overcome this problem, an optional cable can be purchased for the iPod Photo, so that the photos can be viewed on a larger external display device. As shown in FIG. 1, a cable 103 is connected between an analog video output port 104 of the iPod Photo 10 and an available analog video input 106 of a larger display device, e.g., a television or LCD monitor having an analog video input 108.

While use of the cable 103 overcomes the screen-size limitation of the iPod Photo, use of the cable 103 has drawbacks of its own. First, the cable 103 is short, and therefore limits the distance at which the user can be positioned relative to the external display device. Second, the cable 103 restricts the mobility of the user. Third, the cable 103 has to be plugged in unplugged every time the iPod Photo is reconfigured between iPod Photo display and external display use. Finally, use of the cable 103 is cumbersome, and often times, as is true with other wired applications, interferes with or obstructs other activities going on in the environment.

One way of possibly overcoming the required use of a cable might be to use an FM transmitter/receiver, whereby an FM transmitter could be attached to the iPod Photo, and a receiver on the external display device could receive, demodulate and then display the transmitted photos. A problem with this approach, however, is that government standards restrict the amount of power that can be transmitted from an unlicensed FM transmitter. This restriction would, therefore, severely limit the range at which an FM-based system could operate. An FM-based solution would also be undesirable because the transmitted signals could interfere with the operation and use of other electronic devices. Finally, because transmitted FM signals typically radiate in all directions, there is a risk, even though the transmission power may be low, that a neighbor or other user of a similar FM-based receiver could intercept the transmitted signals. Such a risk is undesirable since it raises privacy concerns. For at least these reasons, therefore, an FM transmitter/receiver would not be an optimal solution.

Another way of possibly overcoming use of a cable would be to use Wi-Fi. A problem with Wi-Fi, however, is that it current Wi-Fi standards may, in some applications, be bandwidth limited and may be incapable of transmitting and downloading digital photographs at a rate suitable to a user. In other words, a lapse of time would be experienced in downloading a photograph for display on the external display. In some applications, such delays could be irritating to a user and others waiting to view the downloaded photograph. Another drawback of using Wi-Fi is that, similar to FM, the transmitted Wi-Fi signals are typically transmitted omni-directionally. So, similar to the FM approach, the Wi-Fi approach may be beset with privacy concerns. Encryption/description technology could be designed into the system to overcome the privacy concerns; however, such an introduction could complicate the design and undesirably raise the cost of the resulting system.

It would be desirable, therefore, to have a system or apparatus that would allow photos and other images stored on an iPod Photo or other portable image display/storage device to be displayed on an external display device, without requiring the use of a cable. Such a system or apparatus would allow user mobility, would not be restricted by government radio transmission standards, would protect the privacy of the user, and would allow fast rendering of photographs on the external display.

### SUMMARY OF THE INVENTION

According to a first aspect of the invention, a system for displaying images (e.g. still images (such as photographs), moving images, application program image data, etc.) stored on a portable image display/storage device is disclosed. The portable image display/storage device may be an iPod Photo, MP3/photo player, or other portable image display/storage device. An infrared transmitter (e.g. an infrared transmitter accessory module) having a video input is coupled to a video output of the portable image display/storage device. An infrared receiver having an infrared detector is configured to receive infrared signals transmitted by the infrared transmitter. The infrared signals are modulated by image data from the portable image display/storage device. The image data may be still image data representing photographs (e.g. BMP, GIF, PNG, JPEG, TIFF), moving image data (e.g. MPEGs or other moving image data), image data generated by an application program (e.g. PowerPoint, Word, etc.), or other image data that can be displayed on an external device (e.g. television or computer monitor, LCD display, projector, etc.) or that may be used by another consumer electronics device (e.g. a VCR or DVD player).

According to an embodiment of the invention, the external display device (e.g. LCD display) used to display the images may be housed in a single housing. The infrared receiver may also be housed in the same single housing or attached to the housing. The housing may be of the size that can fit within a clothing pocket of a user.

According to another embodiment of the invention, a consumer electronics accessory kit for a portable image display/storage device is disclosed. The consumer electronics kit includes an infrared transmitter module and an infrared receiver module. The infrared transmitter module includes a video input that a user can easily connect to a video output of a portable image display/storage device. The infrared receiver module includes an infrared detector configured to receive infrared signals from said infrared transmitter module, where the received infrared signals contain image information of one or more images stored on the portable image display/storage device. The image information may be still image data representing photographs (e.g. BMP, GIF, PNG, JPEG, TIFF), moving image data (e.g. MPEGs or other moving image data), image data generated by an application program (e.g. PowerPoint, Word, etc.), or other image data. The infrared receiver module includes a connector that a user can easily connect to a video input of an electronic device. The electronic device may comprise a standard display device such as a television or computer monitor, an LCD display, or may comprise a portable viewer having an LCD display and built-in infrared receiver. Alternatively, the electronic device may also comprise a non-display device such as a VCR or DVD player.

Further aspects of the invention are described and claimed below, and a further understanding of the nature and advantages of the inventions may be realized by reference to the remaining portions of the specification and the attached drawings.

### BRIEF DESCRIPTION OF THE DRAWINGS

FIG. 1 is a simplified diagram of a portable MP3/photo display/storage device that uses a cable to display photographs on an external video display;

FIG. 2 is system diagram of an external display system, illustrating various alternative display and non-display devices, which can be used to display or use images stored on an portable image display/storage device, according to an embodiment of the present invention;

FIG. 3 is a simplified drawing of an external display system, including a portable viewer, which can be used to display images stored on an iPod Photo or other portable image display/storage device, according to another embodiment of the present invention;

FIG. 4 is a simplified electrical schematic of an infrared transmitter accessory, according to an embodiment of the present invention; and

FIG. 5 is a simplified electrical schematic of an infrared transmitter, and portions of a portable viewer, according to an embodiment of the present invention.

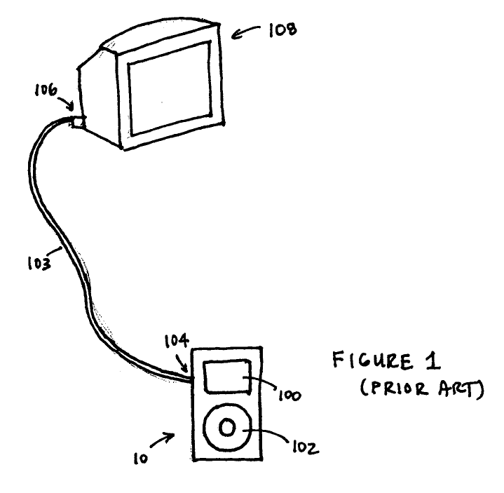

### DETAILED DESCRIPTION

Embodiments of the present invention are described herein in the context of apparatus and systems for implementing the external display of photographs or other image data stored on an iPod Photo, MP3/photo player, or other portable image display/storage device. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. Unless indicated otherwise, the same reference indicators will be used throughout the drawings and the following detailed description to refer to the same or like parts.

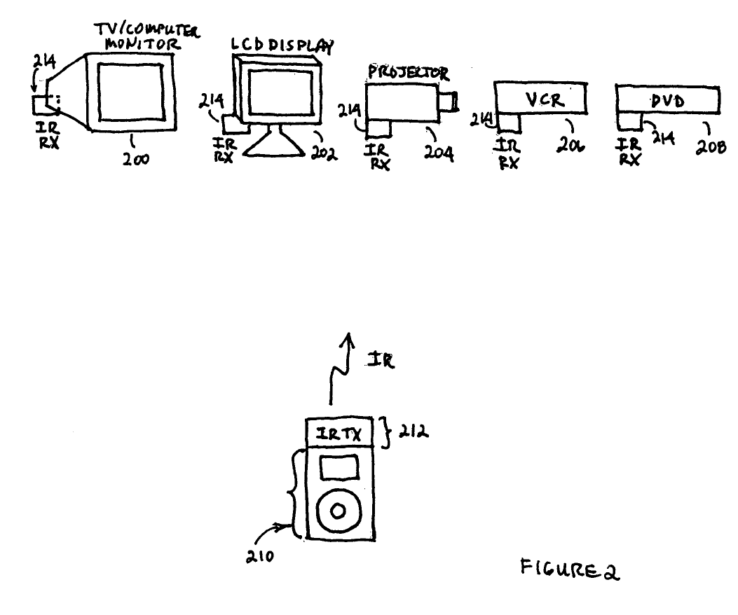

FIG. 2 is a system diagram illustrating various alternative consumer electronic devices (e.g. television or computer monitor 200, liquid crystal display (LCD) 202, projector 204, VCR 206, DVD 208 player/recorder, etc.) that may be configured to receive and/or display photos or other image data stored on an iPod Photo or other portable image display/storage device 210. The iPod Photo or other portable image display/storage device 210 may be capable of storing photographs in BMP, GIF, PNG, JPEG, TIFF (or other still image formats) and may also be capable of storing moving image data (e.g. MPEGs or other moving image data). The iPod Photo or other portable image display/storage device 210 includes an infrared (IR) transmitter accessory 212 that is electrically coupled to an analog video output of the iPod Photo or other portable image display/storage device 210. Each of the television or computer monitor 200, liquid crystal display (LCD) 202, projector 204, VCR 206, DVD 208 player/recorder, etc. includes an IR receiver module 214 that is electrically coupled to an analog video input (e.g. NTSC, PAL, or other analog video standard) of the television or computer monitor 200, liquid crystal display (LCD) 202, projector 204, VCR 206, DVD 208 player/recorder, etc.

The IR transmitter accessory 212 of the iPod Photo or other portable image display/storage device 210 is operable to transmit an IR signal modulated by an analog video output signal from the iPod Photo or other portable image display/storage device 210. The analog video output signal contains an electrical representation of one or more photographs (or other images) stored on the iPod Photo or other portable image display/storage device 210. The IR receiver module 214 of a selected one of the television or computer monitor 200, liquid crystal display (LCD) 202, projector 204, VCR 206, DVD 208 player/recorder, etc. is operable to receive and demodulate the transmitted IR signal to recover the electrical representation of the one or more photographs (or other images) for display. In addition to display devices, a VCR, DVD recorder or other non-display electronic device having an analog video input may be configured to receive the transmitted IR signals. Unlike available prior art systems, external display of the one or more photographs (or other images) is completed without requiring the use of a cable, thereby enhancing user mobility. Because IR transmission/reception is used, restrictions imposed by government radio transmission standards are also avoided. Moreover, the IR transmission is unidirectional, so a user can point the IR transmitter accessory 212 in the direction of the IR receiver module 214 without having to worry about privacy breaches. Finally, in embodiments where analog video is used, near instantaneous viewing of photographs on the external display is enjoyed by the user and other viewers.

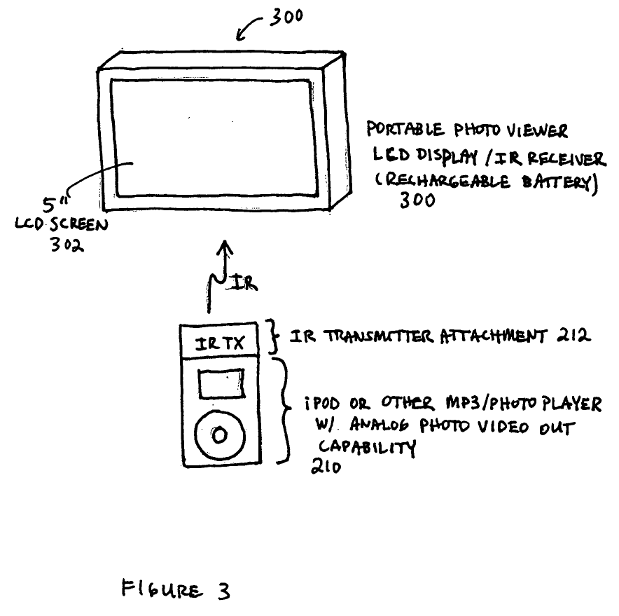

FIG. 3 is a drawing of an external display system for an iPod Photo or other portable image display/storage device 210, according to another embodiment of the present invention. According to this embodiment, a portable viewer 300 having a built-in IR receiver and LCD display 302 is provided. Unlike the display found on existing portable image display/storage devices (e.g. as in the iPod Photo), the portable viewer 300 according to this embodiment of the invention has a much larger display. However, the portable viewer display is preferably not so large that it prevents a user from carrying the viewer around. In this sense, the portable viewer 300 may be though of as a “virtual stack of pictures,” which are of sufficient size and detail to overcome the limitations of the small display of the photo player/storage device, but not so large as to prevent easy portability. The IR receiver and other electronics may be contained within a single housing of the portable viewer 300. According to an embodiment of the invention, the LCD display 302 is a five-inch LCD display 302. According to another embodiment, the portable viewer 300 is of the size that can be easily carried by the user (e.g. in the user's jacket pocket). Rechargeable batteries and an AC/DC adapter may also be configured and housed within the single housing of the portable viewer 300. The iPod Photo or other portable image display/storage device 210 includes an IR transmitter accessory 212, which may be the same or identical to that described above in relation to the embodiment shown in FIG. 2. The IR transmitter accessory 212 transmits, and the IR receiver of the portable viewer 300 receives, IR signals in substantially the same way as described above.

FIG. 4 is a simplified schematic diagram of an exemplary IR transmitter 40, which may be used to implement the IR transmitter accessory 212 described above, according to an embodiment of the present invention. The exemplary IR transmitter includes a high-bandwidth current amplifier 400 having an analog video input 402, which is coupled to the analog video output of the iPod Photo or other portable image display/storage device 210. One or more IR diodes 404 are coupled to the output of the high-bandwidth current amplifier 400. The high-bandwidth current amplifier is operable to amplify analog video signals containing electrical representations of one or more photographs stored on the iPod Photo or other portable image display/storage device 210. The amplified signals are used to modulate an IR signal, which is then transmitted to the IR receiver of the consumer electronic device, e.g., TV or computer monitor 200 or LCD display 202 in FIG. 2, or to the IR receiver in the portable viewer 300 in FIG. 3.

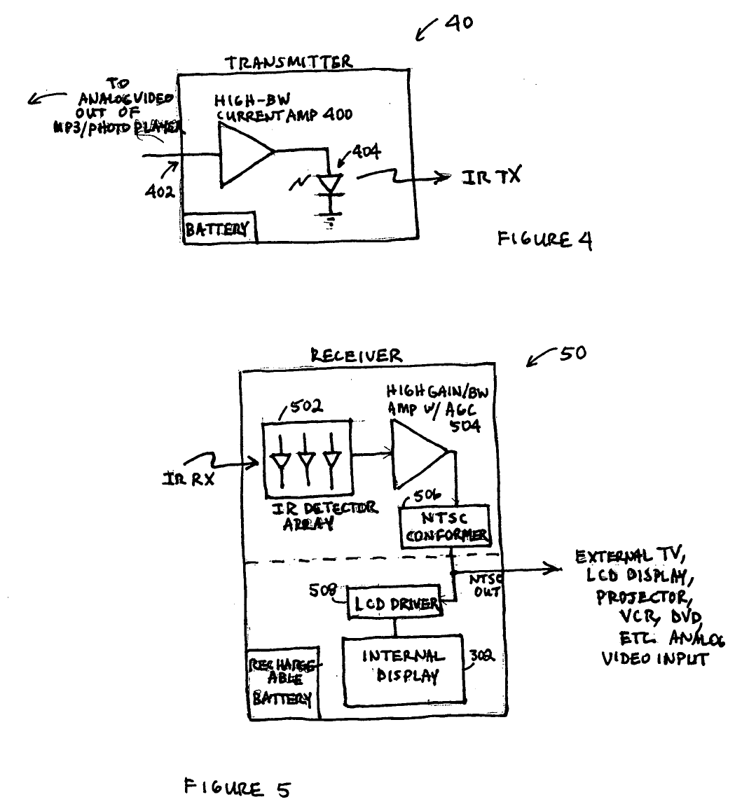

FIG. 5 is a simplified schematic diagram of an exemplary IR receiver 50, which may be used to implement the IR receiver module 214 in the embodiment shown in FIG. 2, or which may be used to implement the IR receiver in the portable viewer 300 in FIG. 3. The IR receiver 50 includes an IR detector array 502 having an electrical output, which is coupled to an input of a high-gain, high-bandwidth amplifier 504. The high-gain, high-bandwidth amplifier 504 may also include automatic gain control (AGC) circuitry to compensate for variations in distance between the IR receiver 50 and the IR transmitter 40. An output of the high-gain, high-bandwidth amplifier 504 is coupled to an input of an analog video conformer 506, which adjusts the signal characteristics of the amplifier signal so that the amplified signal conforms to the analog video standard being used (e.g. NTSC or PAL). The NTSC conformer 506 provides an NTSC-compliant signal at its output. If the portable view 300 is used, this NTSC-compliant signal is coupled to an LCD driver 508, which digitizes the NTSC-compliant signal and provides the control functions necessary to display the received photographs on the internal LCD display 302. Alternatively, if the embodiment shown in FIG. 2 is used, the NTSC-compliant signal is coupled to the analog video input of the television or computer monitor 200, liquid crystal display (LCD) 202, projector 204, VCR 206 or DVD 208 player/recorder.

In addition to displaying photos, the system and apparatus describe above may be used to display any other type of visual information that may be stored on the ipod Photo or other portable image display/storage device 210. For example, information created using an application program, if capable of being stored on the iPod Photo or other portable image display/storage device 210, may be displayed on an external display device using the apparatus and methods described above. For example, according to one embodiment of the invention, PowerPoint slides may be stored on the ipod Photo or other portable image display/storage device 210, and the methods and apparatus described above may be used to present the PowerPoint slides to an audience. In this manner a projector is not required.

While the foregoing description is a complete description of the preferred embodiments of the invention, various alternatives, modifications, and equivalents may be used. For example, whereas analog video techniques have been described in the preferred and exemplary embodiments, those skilled in the art will readily understand that the fundamental aspects of the present invention are not so limited. For example, although in the BACKGROUND SECTION OF THE INVENTION it was explained that current Wi-Fi capabilities are beset with certain bandwidth and privacy concerns, such concerns may not be deemed to be obstacles in certain applications. The discussion of a Wi-Fi possibility was subject matter the present inventor thought of as a possibility, and should, therefore, not be considered prior art. Further, improvements in dealing with bandwidth limitations and privacy concerns (from the perspective of both technology and expense) might possibly be overcome with currently available technology and/or may be improved in the foreseeable future. Accordingly, whereas the preferred and exemplary embodiments of the present invention are described in terms analog video, digital video techniques, including Wi-Fi, are not disclaimed in this application, and those of ordinary skill in the art having the benefit of this disclosure will readily understand and appreciate the design modifications that could be made to accommodate digital video capabilities. Therefore, Wi-Fi and other digital techniques should not be considered as beyond or outside the scope of the presently claimed invention, and the above description, including the BACKGROUND SECTION OF THE INVENTION, should not be considered prior art, and should not be construed as limiting the scope of the invention as it is defined by the appended claims.

What is claimed is:

1. A system for displaying images stored on a portable image display/storage device, comprising:
an infrared transmitter having a video input coupled to a video output of a portable image display/storage device;
an infrared receiver having an infrared detector configured to receive infrared signals from said infrared transmitter, said received infrared signals carrying information representing an image stored on said portable image display/storage device; and
an electronic device having a video input configured to receive said information representing an image stored on said portable image display/storage device.

2. The system of claim 1 wherein said electronic device comprises a display device operable to display said image to a user.

3. The system of claim 2 wherein said display device and said infrared transceiver are housed in a single housing.

4. The system of claim 1 wherein the infrared transmitter comprises an infrared transmitter accessory that can be connected to the portable image display/storage device by a user.

5. The system of claim 2 wherein the display device comprises a television or computer monitor.

6. The system of claim 1 wherein the electronic device comprises a VCR or a DVD player.

7. The system of claim 1 wherein said portable image display/storage device is configured to store digital photographs, and said electronic device is configured to receive electrical signals representing said digital photographs.

8. The system of claim 1 wherein said portable image display/storage device is configured to store digital moving images, and said electronic device is configured to receive electrical signals representing said digital moving images.

9. The system of claim 1 wherein said portable image display/storage device is configured to store images generated by an application program, and said electronic device is configured to receive electrical signals representing said images generated by the application program.

10. The system of claim 3 wherein said housing is of the size that can fit in a clothing pocket of a user.

11. A system for displaying photos stored on a portable MP3 player having photo display/storage capabilities, comprising:
an infrared transmitter having a video input coupled to a video output of a portable MP3 layer having photo display/storage capabilities;
an infrared receiver having an infrared detector configured to receive infrared signals from said infrared transmitter, said received infrared signals modulated by electrical signals representing one or more photos stored on said portable MP3 player having photo display/storage capabilities; and
a display device, separate from said portable MP3 player having photo display/storage capabilities, having a video input configured to receive said modulated infrared signals, and configured to display said one or more photos to a user.

12. The system of claim 11 wherein said display device and said infrared transceiver are housed in a single housing.

13. The system of claim 11 wherein the infrared transmitter comprises an infrared transmitter accessory that can be connected to the MP3 player having photo display/storage capabilities by a user.

14. The system of claim 11 wherein the display device comprises a television or computer monitor.

15. The system of claim 11 wherein the infrared transmitter comprises an infrared transmitter accessory that can be connected to the MP3 player having photo display/storage capabilities by a user.

16. The system of claim 12 wherein said housing is of the size that can fit in a clothing pocket of a user.

17. A consumer electronics accessory kit for a portable image display/storage device, comprising:
an infrared transmitter module having a video input that a user can connect to a video output of a portable image display/storage device; and
an infrared receiver module having an infrared detector configured to receive infrared signals from said infrared transmitter module, said received infrared signals containing image information of one or more images stored on the portable image display/storage device, and said infrared receiver module having a connector that a user can connect to a video input of an electronic device.

18. The consumer electronics accessory kit of claim 17, further comprising a display device, physically separate from the infrared transmitter module, said display device having a housing adapted to house a display operable to display said image information.

19. The consumer electronics accessory kit of claim 18 wherein said infrared receiver module is contained within, or is attached to, said housing.

20. The consumer electronics accessory kit of claim 18 wherein said housing is of the size that can fit in a clothing pocket of the user.

21. The consumer electronics accessory kit of claim 17 wherein said electronic device comprises a television or a computer monitor.

22. The consumer electronics accessory kit of claim 18 wherein said portable image display/storage device is configured to store moving image data, and said electronic display device is configured to display images of said stored moving image data.

23. The consumer electronics accessory kit of claim 18 wherein said portable image display/storage device is configured to store image data generated by an application program, and said electronic display device is configured to display images of said image data generated by the application program.

24. The consumer electronics accessory kit of claim 17 wherein the electronic device comprises a display device having a housing of the size that can fit in a clothing pocket of the user.
